(19) United States
(12) Patent Application Publication
(10) Pub. No.: US 2011/0022432 A1
(43) Pub. Date: Jan. 27, 2011

(54) WORK INFORMATION PROCESSING APPARATUS, PROGRAM, AND WORK INFORMATION PROCESSING METHOD

(76) Inventors: Tomotoshi Ishida, Hitachinaka (JP); Yushi Sakamoto, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/742,739

(22) PCT Filed: Nov. 4, 2008
(86) PCT No.: PCT/JP2008/070014

§ 371 Date: Aug. 23, 2010

(30) Foreign Application Priority Data
Nov. 14, 2007 (JP) 2007-295185

(51) Int. Cl. G06Q 10/00

(52) U.S. Cl. 705/7

(57) ABSTRACT

To measure an action of a worker and analyze the measurement data to determine the type of the action and also determine the type of a work, thereby providing information for improving the work itself. A work information processing apparatus (110) receives, via an antenna (143), detection values obtained by sensors (101A, 101B, 101C); determines, from an action information table, actions corresponding to the received detection values; arranges the actions in time sequence; and determines, from a work dictionary table, a work corresponding to the actions arranged in time sequence, thereby determining the actions and the work for each of workers.

### TECHNICAL FIELD

The present invention relates to a technology of determining an action and a work of a worker.

### BACKGROUND ART

In order to improve various operations such as assembling, machining, transportation, inspection, and maintenance, it is generally carried out to grasp a situation of a work that is currently performed and extract problems involved therein for the improvements.

For example, Patent Document 1 discloses a technology of providing a guide to an improvement method by observing work methods of a skilled worker and an unskilled worker, measuring work states of the workers by a measurement apparatus in order to distinguish a difference therebetween, and quantitatively comparing the difference in action.

Patent Document 1: Japanese Patent Laid-open Publication No. 2002-333826

### DISCLOSURE OF THE INVENTION

### Problem to be Solved by the Invention

According to the technology disclosed in Patent Document 1, partial actions of a work performed by one worker may be analyzed. However, a summation processing may not be performed with regard to the work performed by combining actions, for example, what kind of works have been performed based on what kind of time allocation through one day.

Therefore, an object of the present invention is to measure an action of a worker and analyze data on the measurement to determine an action type and a work type, thereby providing information for improving the work itself.

### Means for Solving the Problem

In order to solve the above-mentioned problem, according to the present invention, an action corresponding to detection values obtained from sensors attached to a worker is determined, and a work is determined based on the determined action.

For example, according to the present invention, there is provided a work information processing apparatus, including: a storage unit which stores: action dictionary information for determining detection information determining a detection value obtained by a sensor which senses an action, and the action corresponding to the detection information; and work dictionary information for determining combination information determining a combination of actions in time sequence, and a work corresponding to the combination information; and a control unit, in which the control unit performs: a processing of determining actions corresponding to detection values obtained by the sensor owned by a worker from the action dictionary information; a processing of determining a combination of the determined actions in time sequence, and determining a work corresponding to the determined combination from the work dictionary information; and a processing of generating work information for determining actions and works in time sequence for each of the workers.

### EFFECT OF THE INVENTION

As described above, according to the present invention, the information for improving the work itself may be provided by measuring the action of the worker and analyzing data on the measurement to determine an action type and a work type.

### BRIEF DESCRIPTION OF THE DRAWINGS

FIG. 1 is a schematic diagram of a work data processing system.

FIG. 2 is a schematic diagram of a work information processing apparatus.

FIG. 3 is a schematic diagram of a measurement table.

FIG. 4 is a schematic diagram of an action dictionary table.

FIG. 5 is a schematic diagram of an action table.

FIG. 6 is a schematic diagram of a work dictionary table.

FIG. 7 is a schematic diagram of a work table.

FIG. 8 is a schematic diagram of a correlation table.

FIG. 9 is a schematic diagram of a grouping table.

FIG. 10 is a schematic diagram illustrating results of performing Fourier transform on measurement values.

FIG. 11 is a schematic diagram of an action table after a normalization processing.

FIG. 12 is a schematic diagram of output information.

FIG. 13 is a schematic diagram of a computer.

FIG. 14 is a flowchart illustrating a processing performed by the work information processing apparatus.

FIG. 15 is a flowchart illustrating a processing performed by an action analysis unit.

FIG. 16 is a flowchart illustrating a processing performed by a work analysis unit.

FIG. 17 is a schematic diagram of a work information processing apparatus.

FIG. 18 is a schematic diagram of an improvement idea table.

FIG. 19 is a schematic diagram illustrating an example of improvement idea information.

FIG. 20 is a schematic diagram of a work data processing system.

FIG. 21 is a schematic diagram of a work information processing apparatus.

FIG. 22 is a schematic diagram of a position measurement table.

FIG. 23 is a schematic diagram of a correlation table.

FIG. 24 is a schematic diagram of a position determination table.

FIG. 25 is a schematic diagram of a position table.

FIG. 26 is a schematic diagram of a search condition input screen.

FIG. 27 is a schematic diagram of an output screen.

FIG. 28 is a flowchart illustrating a processing of generating an output screen.

FIG. 29 is a schematic diagram of a display screen.

FIG. 30 is a schematic diagram of a display screen.

FIG. 31 is a schematic diagram of a display screen.

FIG. 32 is a schematic diagram of a display screen.

FIG. 33 is a schematic diagram of output information.

### DESCRIPTION OF SYMBOLS

100, 300 work data processing system
101 sensor
302 position sensor
110, 210, 310 work information processing apparatus
120, 220, 320 storage unit
121, 321 measurement information storage area
122 action dictionary information storage area
123 action information storage area
124 work dictionary information storage area
125 work information storage area
126, 326 environment information storage area
227 improvement idea information storage area
328 position determination information storage area
329 position information storage area
130, 230, 330 control unit
131, 331 measurement information management unit
132 action analysis unit
133 work analysis unit
134, 234, 334 output information generation unit
335 position analysis unit
140 input unit
141 output unit
142 communication unit

### BEST MODE FOR CARRYING OUT THE INVENTION

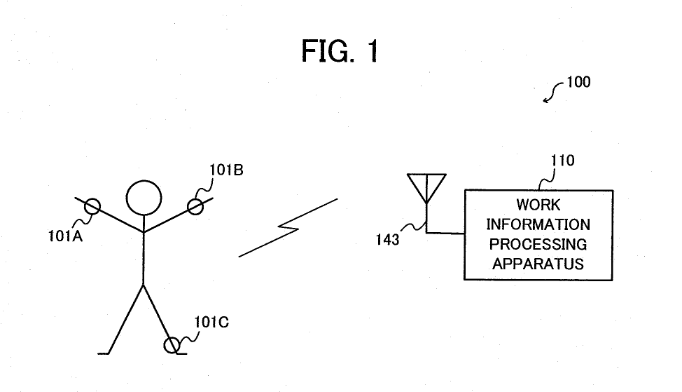

FIG. 1 is a schematic diagram of a work data processing system 100 according to the present invention.

The work data processing system 100 according to the present invention includes sensors 101A, 101B, and 101C (hereinafter, referred to as “sensors 101” unless the individual sensors are particularly distinguished from each other) and a work information processing apparatus 110.

The sensors 101 are sensors which detect an action of a person to which the sensors 101 are attached. In this embodiment, an acceleration sensor which measures accelerations in three directions perpendicular to one another is used. However, the present invention is not limited to such a mode.

Note that the sensor 101A is attached to a right hand of a worker, the sensor 101B is attached to a left hand of the worker, and the sensor 101C is attached to a left foot. However, the present invention is not limited to such a mode as long as movements of a plurality of portions of the worker may be detected by a plurality of sensors.

Further, the sensors 101 transmit detection values that have been detected to the work information processing apparatus 110 via radio.

The work information processing apparatus 110 receives by an antenna 143 the detection values transmitted from the sensors 101.

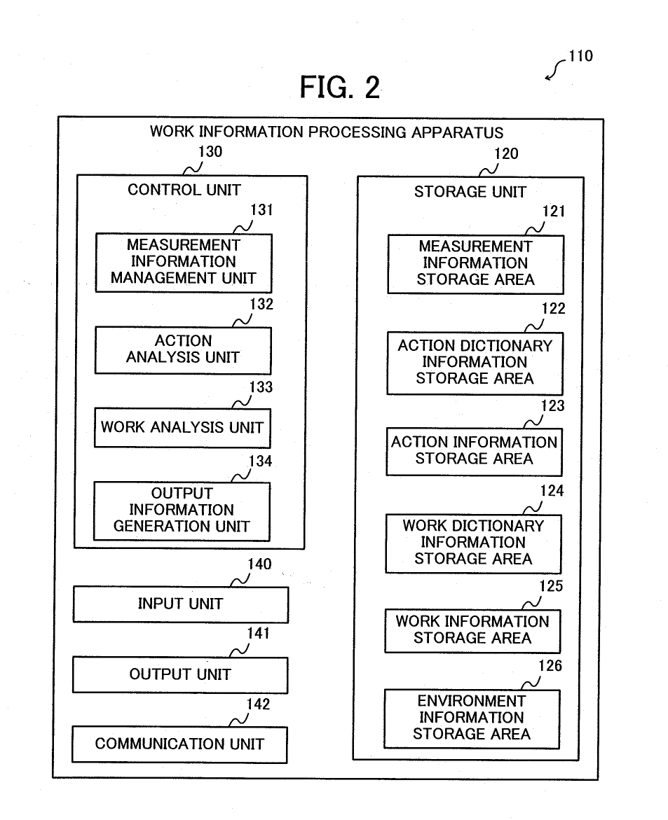

FIG. 2 is a schematic diagram of the work information processing apparatus 110.

As illustrated in the figure, the work information processing apparatus 110 includes a storage unit 120, a control unit 130, an input unit 140, an output unit 141, and a communication unit 142.

The storage unit 120 includes a measurement information storage area 121, an action dictionary information storage area 122, an action information storage area 123, a work dictionary information storage area 124, a work information storage area 125, and an environment information storage area 126.

The detection values detected by the sensors 101 are stored in the measurement information storage area 121.

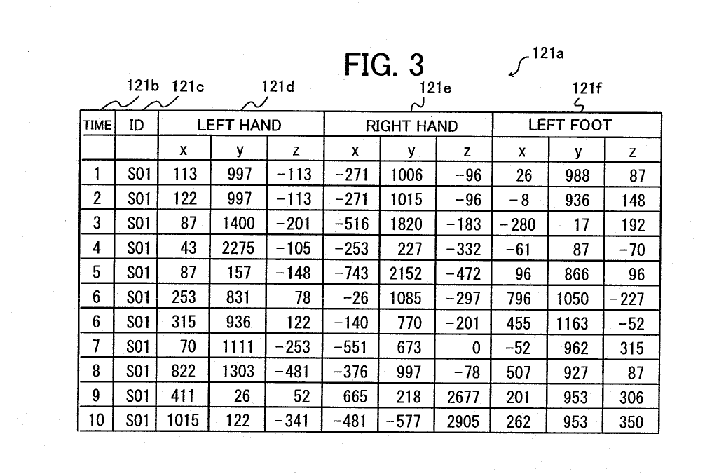

For example, a measurement table 121a as illustrated in FIG. 3 (schematic diagram of the measurement table 121a) is stored in the measurement information storage area 121.

The measurement table 121a includes a time field 121b, an ID field 121c, a left hand field 121d, a right hand field 121e, and a left foot field 121f.

Stored in the time field 121b is information determining a time at which the detection values detected by the sensors 101 are received.

Note that times of respective records may be determined by setting the detection values to be periodically transmitted from the sensors 101 and by setting specific times to be managed by the work information processing apparatus 110 in association with the values stored in the time field 121b.

Stored in the ID field 121c is information determining an ID which is identification information for identifying the sensors 101.

Here, in this embodiment, one ID is assigned to a set of the sensors 101A, 101B, and 101C that are attached to one worker.

Stored in the left hand field 121d are detection values (accelerations) detected by the sensor 101B of the set of the sensors 101 determined by the ID field 121c. Here, in this embodiment, a three-axis acceleration sensor is used as each of the sensors 101, and hence the respective detection values of an x-axis, a y-axis, and a z-axis are stored.

Stored in the right hand field 121e are detection values (accelerations) detected by the sensor 101A of the set of the sensors 101 determined by the ID field 121c. Here, the respective detection values of an x-axis, a y-axis, and a z-axis are also stored.

Stored in the left foot field 121f are detection values (accelerations) detected by the sensor 101C of the set of the sensors 101 determined by the ID field 121c. Here, the respective detection values of an x-axis, a y-axis, and a z-axis are also stored.

Note that by attaching a sensor ID which is identification information uniquely assigned to each of the sensors to the detection values transmitted from the sensors 101, it is possible to configure the work information processing apparatus 110 to manage the IDs corresponding to the sensor ID, and store the detection values detected by the respective sensors 101 into the corresponding fields 121d, 121e, and 121f.

Referring back to FIG. 2, information for determining an action from the detection values of the sensors 101 is stored in the action dictionary information storage area 122.

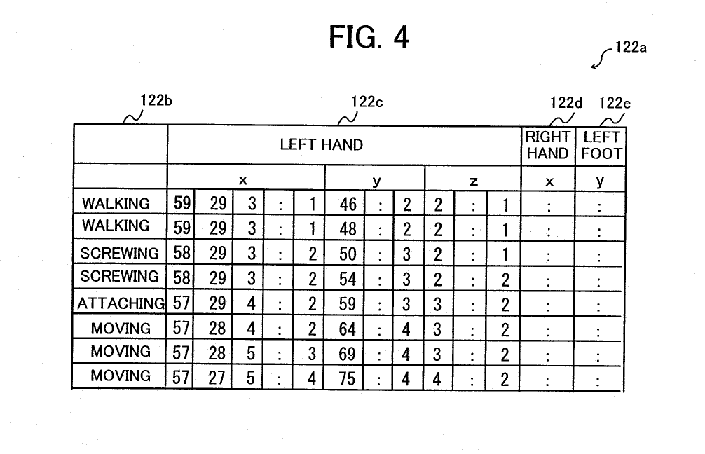

For example, in this embodiment, an action dictionary table 122a as illustrated in FIG. 4 (schematic diagram of the action dictionary table 122a) is stored.

As illustrated in the figure, the action dictionary table 122a includes an action field 122b, a left hand field 122c, a right hand field 122d, and a left foot field 122e.

Stored in the action field 122b is information determining an action that constitutes a work performed by the worker.

Stored in the left hand field 122c are values obtained by performing Fourier transform on the detection values detected by the sensors 101 in the action determined by the action field 122b. Note that stored in the field are values obtained by performing Fourier transform on the detection values detected in advance by the sensor 101 attached to the left hand after the worker performs the action determined by the action field 122b.

Stored in the right hand field 122d are values obtained by performing Fourier transform on the detection values detected by the sensors 101 in the action determined by the action field 122b. Note that stored in the field are values obtained by performing Fourier transform on the detection values detected in advance by the sensor 101 attached to the right hand after the worker performs the action determined by the action field 122b.

Stored in the left foot field 122e are values obtained by performing Fourier transform on the detection values detected by the sensors 101 in the action determined by the action field 122b. Note that stored in the field are values obtained by performing Fourier transform on the detection values detected in advance by the sensor 101 attached to the left foot after the worker performs the action determined by the action field 122b.

Referring back to FIG. 2, information in which an action corresponding to measurement values measured by the sensors 101 is determined is stored in the action information storage area 123.

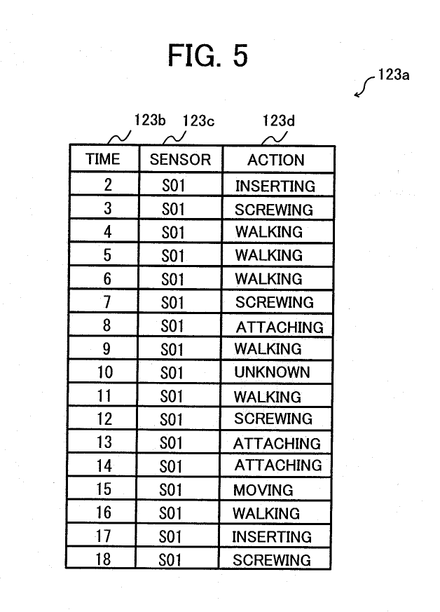

For example, in this embodiment, an action table 123a as illustrated in FIG. 5 (schematic diagram of the action table 123a) is stored.

The action table 123a includes a time field 123b, a sensor field 123c, and an action field 123d.

Stored in the time field 123b is information determining the time at which the detection values detected by the sensors 101 are received. Here, stored in this field is the information corresponding to the time field 121b of the measurement table 121a.

Stored in the sensor field 123c is information determining the ID which is identification information for identifying the sensors 101. Here, stored in this field is the information corresponding to the ID field 121c of the measurement table 121a.

Stored in the action field 123d is information determining the action corresponding to the detection values detected by the sensors 101 determined by the sensor field 123c at the time determined by the time field 123b. Note that in this embodiment, the character string “unclear” is stored if the detection values that are not associated with any actions in the action table 123a are detected.

Referring back to FIG. 2, information for determining a work corresponding to a combination of actions is stored in the work dictionary information storage area 124.

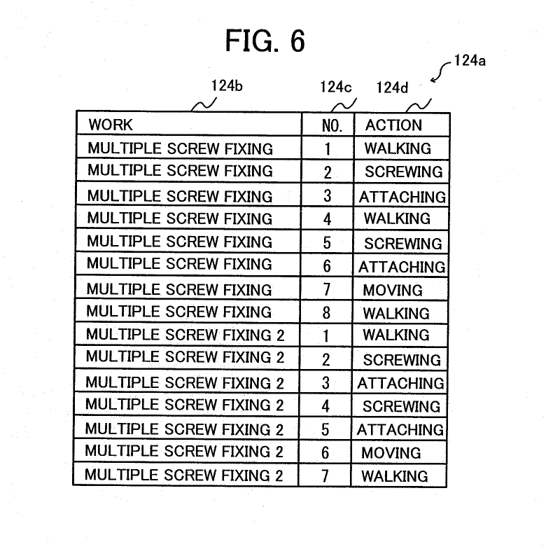

For example, in this embodiment, a work dictionary table 124a as illustrated in FIG. 6 (schematic diagram of the work dictionary table 124a) is stored.

As illustrated in the figure, the work dictionary table 124a includes a work field 124b, a NO. field 124c, and an action field 124d.

Stored in the work field 124b is information determining a work determined by a plurality of actions. Here, information determining the work “multiple screw fixing” and information determining the work “multiple screw fixing 2” are stored as the works, but the present invention is not limited to such a mode.

Stored in the NO. field 124c is information determining a sequence of actions stored in the action field 124d described later. Here, in this embodiment, information determining natural numbers to be serial numbers starting from “1” is stored as the information determining the sequence of actions, but the present invention is not limited to such a mode.

Stored in the action field 124d is information determining an action that constitutes the work determined by the work field 124b.

Referring back to FIG. 2, information for determining the action corresponding to the measurement values measured by the sensors 101 and determining the work is stored in the work information storage area 125.

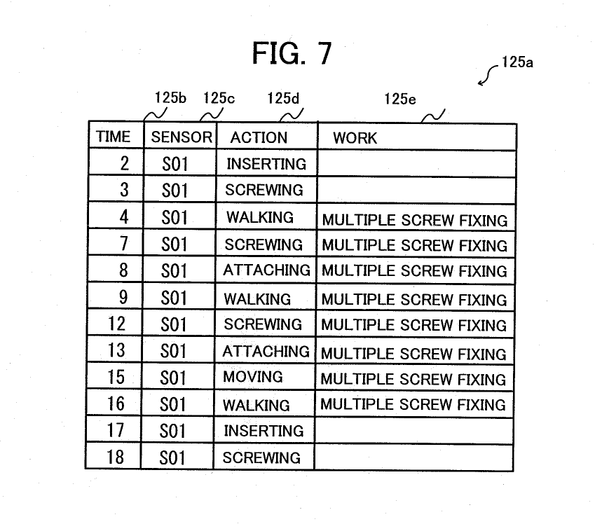

For example, in this embodiment, a work table 125a as illustrated in FIG. 7 (schematic diagram of the work table 125a) is stored.

The work table 125a includes a time field 125b, a sensor field 125c, an action field 125d, and a work field 125e.

Stored in the time field 125b is information determining the time at which the detection values detected by the sensors 101 are received. Here, stored in this field is the information corresponding to the time field 123b of the action table 123a.

Stored in the sensor field 125c is information determining the ID which is identification information for identifying the sensors 101. Here, stored in this field is the information corresponding to the sensor field 123c of the action table 123a.

Stored in the action field 125d is information determining the action corresponding to the detection values detected by the sensors 101 determined by the sensor field 125c at the time determined by the time field 125b. Here, stored in this field is the information corresponding to the action field 123d of the action table 123a.

Stored in the work field 125e is information determining the work corresponding to the combination of actions determined by the action field 125d. Here, in this embodiment, a name of a work is stored as the information determining the work, but the present invention is not limited to such a mode. Note that in this embodiment, a field corresponding to the action that is not associated with any works in the work dictionary table 124a is left blank.

Referring back to FIG. 2, information for determining an environment of the worker is stored in the environment information storage area 126.

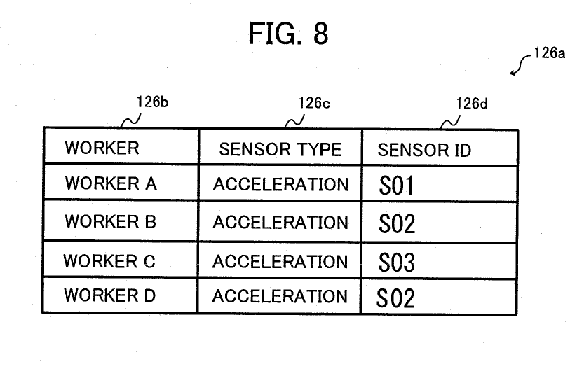

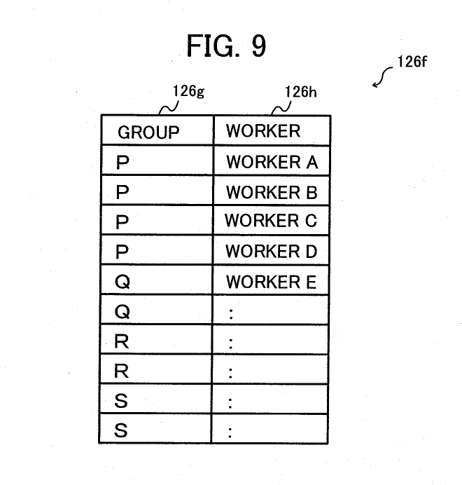

For example, in this embodiment, a correlation table 126a as illustrated in FIG. 8 (schematic diagram of the correlation table 126a) is stored as information for determining a correlation between the worker and the sensors 101, and a grouping table 126f as illustrated in FIG. 9 (schematic diagram of the grouping table 126f) is stored as information for determining grouping of workers.

As illustrated in FIG. 8, the correlation table 126a includes a worker field 126b, a sensor type field 126c, and a sensor ID field 126d.

Stored in the worker field 126b is identification information (in this embodiment, name of the worker) for identifying the worker.

Stored in the sensor type field 126c is information determining the type of the sensors attached to the worker determined by the worker field 126b.

Stored in the sensor ID field 126d is information determining the set of the sensors attached to the worker determined by the worker field 126b.

As illustrated in FIG. 9, the grouping table 126f includes a group field 126g and a worker field 126h.

Stored in the group field 126g is identification information (in this embodiment, group name) for identifying the group of workers.

Stored in the worker field 126h is identification information (in this embodiment, name of the worker) for identifying a worker belonging to the group determined by the group field 126g.

Referring back to FIG. 2, the control unit 130 includes a measurement information management unit 131, an action analysis unit 132, a work analysis unit 133, and an output information generation unit 134.

The measurement information management unit 131 performs a processing of storing the measurement values received from the respective sensors 101 via the communication unit 142 described later into the measurement table 121a.

Note that, stored in the measurement information management unit 131 are correlations between the sensor IDs of the respective sensors 101 and the IDs for identifying the set of the plurality of sensors 101A, 101B, and 101C that are attached to the worker. The ID corresponding to the sensor ID attached to the measurement values received from the respective sensors 101 is stored in the ID field 121c of the measurement table 121a.

The action analysis unit 132 performs a processing of determining, from the measurement values stored in the measurement table 121a, the action corresponding to the measurement values.

Specifically, the action analysis unit 132 extracts the measurement values stored in the measurement table 121a on a time basis, and performs Fourier transform on the extracted measurement values into frequency components. Here, in this embodiment, Fourier transform is performed on each of the detection values acquired from the respective sensors 101 of the left hand, the right hand, and the left foot.

Here, Fourier transform is one method for a signal analysis, transforming measurement data into parameters of frequency-basis weights. In this embodiment, the measurement values are processed by being digitized, and hence FFT is used for a frequency analysis on digital values.

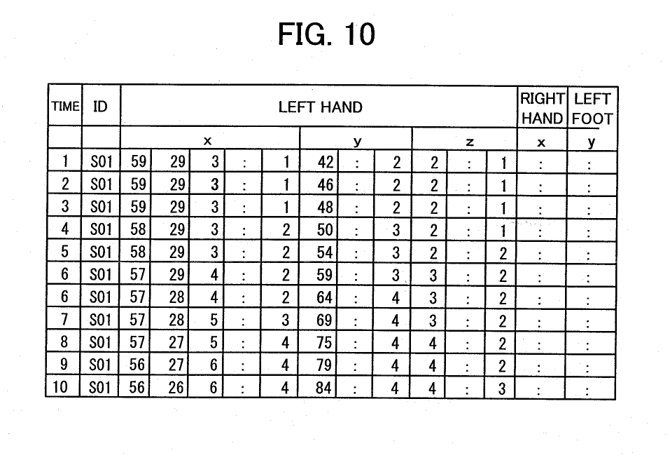

Note that FIG. 10 (schematic diagram illustrating results of performing Fourier transform on measurement values) is a schematic diagram illustrating results of performing Fourier transform on the information stored in the measurement table 121a illustrated in FIG. 3.

Then, the action analysis unit 132 determines a record in which the values obtained by performing Fourier transform on a time basis are matched with or similar to the values stored in the left hand field 122c, the right hand field 122d, and the left foot field 122e in the action dictionary table 122a, and judges the action stored in the action field 122b of the determined record as the action at the corresponding time.

Here, the action analysis unit 132 determines the record in which the values obtained by performing Fourier transform on the detection values detected from the left hand, the right hand, and the left foot on a time basis are matched with or similar to the values stored in the left hand field 122c, the right hand field 122d, and the left foot field 122e, respectively, in the action dictionary table 122a, thereby allowing the action of the worker to be determined from movements of a plurality of portions of the corresponding worker detected by the plurality of sensors.

Note that a method of least squares which selects a record having a minimum sum of squares of a difference between values in respective columns is generally used for determining the similarity, but the present invention is not limited to such a method.

Further, with regard to the judgment of the matching, instead of perfect matching, the matching may be judged if there is a matching within a predetermined frequency range (for example, range excluding at least one of a specific high frequency part and a specific low frequency part).

Note that if the values obtained by performing Fourier transform on a time basis are not matched with or similar to the values stored in the left hand field 122c, the right hand field 122d, and the left foot field 122e in the action dictionary table 122a, the action analysis unit 132 judges the action at the corresponding time as unknown.

Then, by compiling the actions thus retrieved on a time basis, the action analysis unit 132 generates the action table 123a as illustrated in FIG. 5, and stores the action table 123a in the action information storage area 123.

The work analysis unit 133 performs a normalization processing on the information determining the action stored in the action table 123a stored in the action information storage area 123.

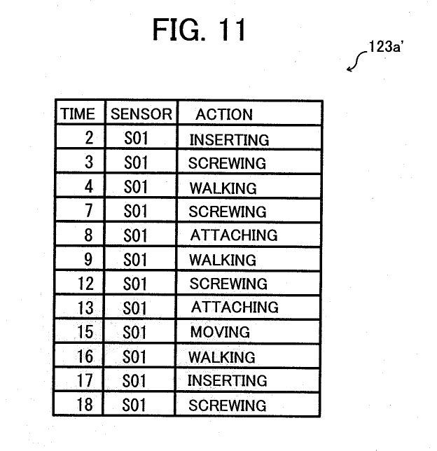

The normalization processing here represents a processing of compiling a serial section of the same actions into one action and deleting a section in which the character string “unknown” is stored. FIG. 11 is a schematic diagram of an action table 123a′ after the normalization processing which is obtained by performing the normalization processing on the action table 123a illustrated in FIG. 5.

Next, the work analysis unit 133 judges whether or not an arbitrary combination of the actions stored in the action table 123a′ after the normalization processing (arbitrary combination in a time series) is stored in the action field 124d of the work dictionary table 124a.

Then, the work analysis unit 133 newly adds the work field 125e to the action table 123a′ obtained after the normalization processing, extracts the information determining the work from the work field 124b of the record of the work dictionary table 124a with the action field 124d including a combination of the actions stored in the action field 123d of the action table 123a′, and stores the information into the corresponding work field 125e, thereby generating the work table 125a.

The work analysis unit 133 stores the work table 125a thus generated in the work information storage area 125.

The output information generation unit 134 performs a processing of receiving an input of a search condition via the input unit 140 described later, extracting information corresponding to the input search condition from the work information storage area 125, and outputting the information in a predetermined format.

Here, in this embodiment, such a processing is performed as to receive an input of the name of the worker or the group name via the input unit 140 and to output, to the output unit 141, information determining the action of the worker included in the group determined by the name of the worker or the group name, information determining the work, and information determining the time at which the action and the work are performed.

Note that if the name of the worker is input via the input unit 140, the output information generation unit 134 acquires the sensor ID corresponding to the worker from the correlation table 126a, and extracts the time, the action, and the work that correspond to the acquired sensor ID from the work table 125a.

Further, if the group name is input via the input unit 140, the output information generation unit 134 extracts the name of the worker belonging to the corresponding group from the grouping table 126f, acquires the sensor ID corresponding to the extracted worker from the correlation table 126a, and extracts the time, the action, and the work that correspond to the acquired sensor ID from the work table 125a.

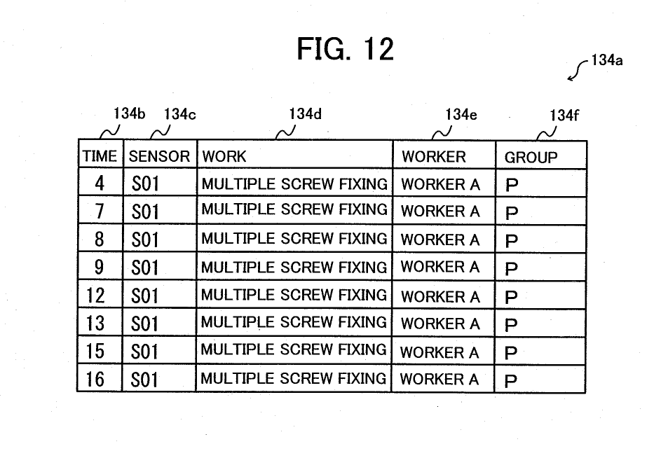

FIG. 12 is a schematic diagram of output information 134a output to the output unit 141 by the output information generation unit 134.

The output information 134a includes a time field 134b, a sensor field 134c, a work field 134d, a worker field 134e, and a group field 134f, in each of which information extracted by the output information generation unit 134 and its related information are stored.

The input unit 140 receives an input of information.

The output unit 141 outputs information.

The communication unit 142 performs transmission/reception of information via the antenna 143.

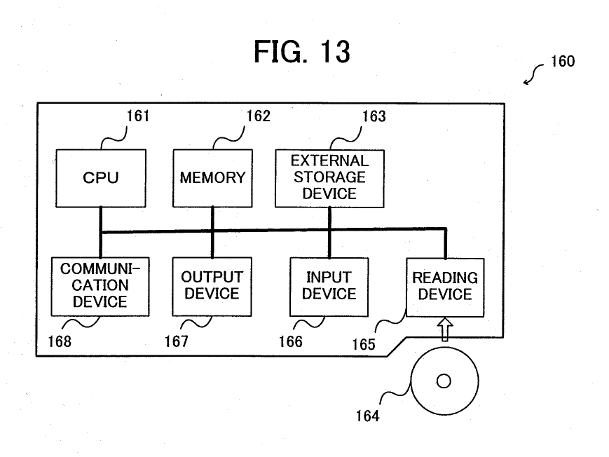

The work information processing apparatus 110 described above may be implemented on, for example, a general computer 160 as illustrated in FIG. 13 (schematic diagram of the computer 160) which includes a central processing unit (CPU) 161, a memory 162, an external storage device 163 such as a hard disk drive (HDD), a reading device 165 which reads information from a storage medium 164 having portability such as a compact disk read only memory (CD-ROM) or a digital versatile disk read only memory (DVD-ROM), an input device 166 such as a keyboard and a mouse, an output device 167 such as a display, and a communication device 168 such as a radio communication unit which performs radio communications via an antenna.

For example, the storage unit 120 may be implemented when the CPU 161 uses the memory 162 or the external storage device 163. The control unit 130 may be implemented when a predetermined program stored in the external storage device 163 is loaded into the memory 162 and executed by the CPU 161. The input unit 140 may be implemented when the CPU 161 uses the input device 166. The output unit 141 may be implemented when the CPU 161 uses the output device 167. The communication unit 142 may be implemented when the CPU 161 uses the communication device 168.

The predetermined program may be downloaded onto the external storage device 163 from the storage medium 164 via the reading device 165 or from a network via the communication device 168, then loaded into the memory 162, and executed by the CPU 161. Further, the predetermined program may be loaded directly into the memory 162 from the storage medium 164 via the reading device 165 or from the network via the communication device 168, and executed by the CPU 161.

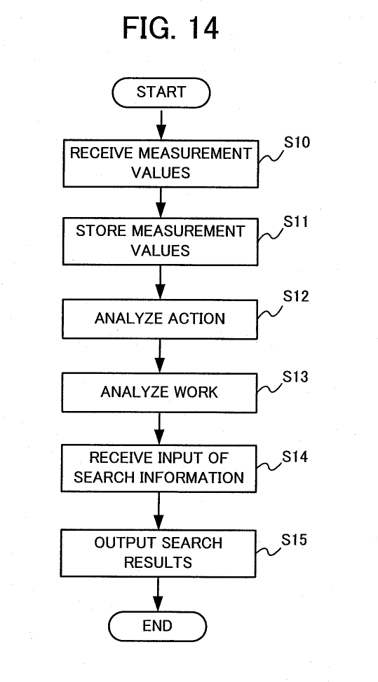

FIG. 14 is a flowchart illustrating a processing performed by the work information processing apparatus 110.

First, the measurement information management unit 131 of the work information processing apparatus 110 receives measurement values from the respective sensors 101 via the communication unit 142 (S10).

Then, the measurement information management unit 131 stores the received measurement values into the measurement table 121a stored in the measurement information storage area 121 (S11).

Subsequently, the action analysis unit 132 of the work information processing apparatus 110 combines values obtained by performing Fourier transform on the measurement values stored in the measurement table 121a and values obtained from the plurality of sensors 101 attached to one worker, and determines an action corresponding to the combined values from the action field 122b of the action table 122a (S12). Note that the action analysis unit 132 stores the determined actions into the action table 123a in time sequence, and stores the action table 123a into the action information storage area 123.

Here, the processing by the action analysis unit 132 may be performed periodically, for example, once a day, or may be performed by receiving an input of an analysis instruction specifying a time interval for the analysis via the input unit 140.

Subsequently, the work analysis unit 133 of the work information processing apparatus 110 normalizes the information stored in the action table 123a, and determines the work corresponding to the normalized action from the work field 124b of the work dictionary table 125a stored in the work dictionary information storage area 124 (S13). Note that the work analysis unit 133 stores the determined works and the actions corresponding to the works into the work table 125a in time sequence, and stores the work table 125a into the work information storage area 125.

Then, the output information generation unit 134 of the work information processing apparatus 110 receives an input of the search condition such as the name of the worker or the group name via the input unit 140 (S14), extracts the information corresponding to the received search condition from the work table 125a stored in the work information storage area 125, and outputs the information to the output unit 141 in the predetermined output format (S15).

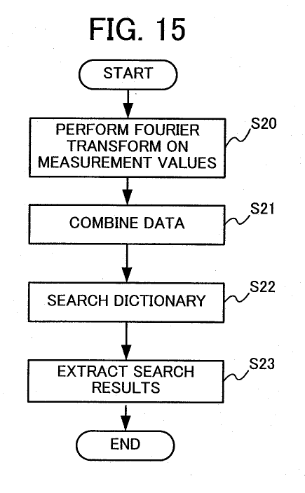

FIG. 15 is a flowchart illustrating a processing performed by the action analysis unit 132 of the work information processing apparatus 110.

First, the action analysis unit 132 performs Fourier transform on the measurement values stored in the measurement table 121a stored in the measurement information storage area 121 (S20).

Subsequently, the action analysis unit 132 combines the values obtained by performing Fourier transform in Step S20 as values obtained from the sensors 101 attached to one worker in an arrangement of the left hand, the right hand, and the left foot in the stated order (S21). In other words, by arranging the values obtained by performing Fourier transform on the measurement values obtained from the sensors 101 attached to one worker in the order of the left hand, the right hand, and left foot, the combination of those values is set as one data row.

Subsequently, the action analysis unit 132 determines the action corresponding to the values combined in Step S21 from the action dictionary table 122a stored in the action dictionary information storage area 122 (S22).

Then, the action analysis unit 132 extracts the actions determined in Step S22 and arranges the actions in time sequence to thereby generate the action table 123a and store the action table 123a into the action information storage area 123 (S23).

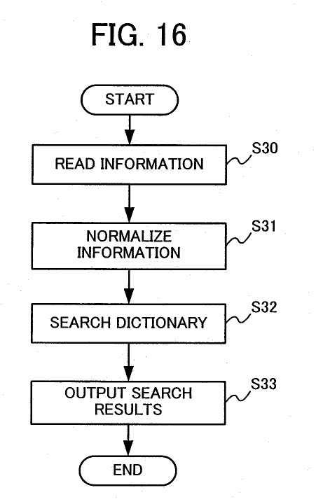

FIG. 16 is a flowchart illustrating a processing performed by the work analysis unit 133 of the work information processing apparatus 110.

First, the work analysis unit 133 reads the action table 123a stored in the action information storage area 123 (S30).

Subsequently, the work analysis unit 133 performs the normalization of the information in the action field 123d of the read action table 123a by deleting the record stored with “unknown” while compiling the serial records in which the same actions are stored into one record (S31).

Then, the work analysis unit 133 extracts the work corresponding to a plurality of serial actions stored in the action field 123d of the normalized action table 123a from the work dictionary table 124a stored in the work dictionary information storage area 124 (S32), generates the work table 125a in which the actions and the works are arranged in time sequence, and stores the work table 125a into the work information storage area 125 (S33).

In the embodiment described above, the action analysis unit 132 performs Fourier transform on the measurement values, but the present invention is not limited to such a mode. For example, assuming that an average value of the measurement values in a predetermined segment at least one of before and after a specific time is set as the value at the specific time, the corresponding action may be extracted from the action dictionary table (such an average value is prestored in the left hand field, the right hand field, and the left foot field of the action table as well). By performing such a processing, it is possible to weaken components of subtle changes, i.e., fluctuations, in acceleration, and only data representing an action corresponding to a large change remains. Therefore, an appropriate action may be determined.

Further, in the embodiment described above, the action analysis unit 132 determines the action having the highest similarity to the value obtained by performing Fourier transform in Step S22 of FIG. 15, but the present invention is not limited to such a mode. For example, a plurality of candidates of actions are previously determined in a descending order of the similarity, an appropriate candidate may be selected by matching the plurality of candidates of actions with the work dictionary table 124a.

For example, if the candidate of action at a given time point as a result of the action analysis is “screwing” or “pushing” and the actions before and after that are “walking” and “attaching”, the action column has candidates of “walking”, “screwing”, and “attaching” or “walking”, “pushing”, and “attaching”. Here, if a work corresponding to any one of the candidates exists in the work dictionary table 124a, it may be judged to be highly probable that a work exists in the column of those actions.

As described above, according to the present invention, a comprehensive analysis may be performed by handling a plurality of candidates with the action analysis and the work analysis in conjunction with each other.

Further, in this embodiment, the action analysis and the work analysis are performed from the measurement values, but the present invention is not limited to such a mode. For example, by providing an operation dictionary table in which a column of works and a column of operations corresponding to the column of works are stored, it is also possible to analyze the operation corresponding to the column of works (which is desirably normalized in the same manner as the above-mentioned embodiment) determined by the work analysis unit 133.

Next, description is made of a second embodiment of the present invention. Note that the second embodiment is different from the first embodiment in a work information processing apparatus 210. Therefore, hereinafter, description is made of the work information processing apparatus 210.

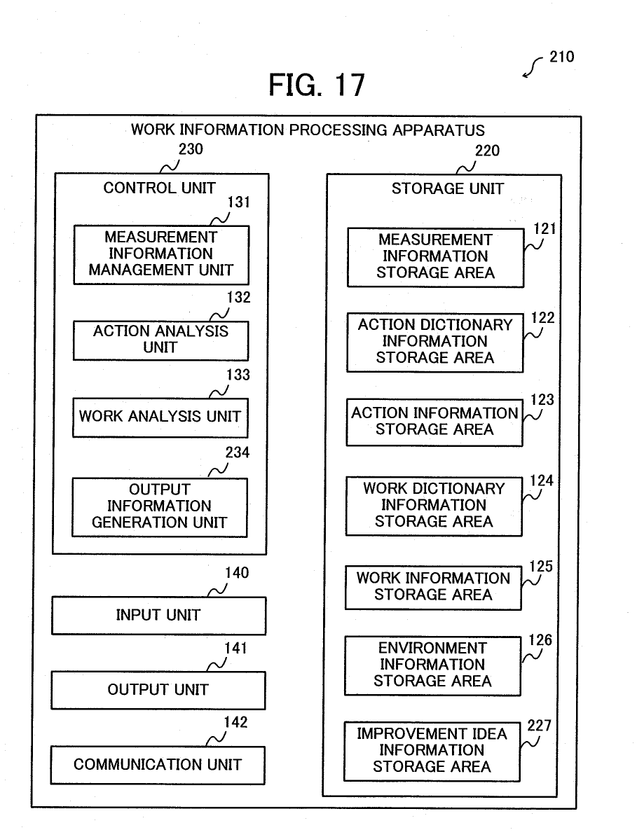

FIG. 17 is a schematic diagram of the work information processing apparatus 210.

As illustrated in the figure, the work information processing apparatus 210 includes a storage unit 220, a control unit 230, the input unit 140, the output unit 141, and the communication unit 142, and is different from the first embodiment in the storage unit 220 and the control unit 230. Therefore, hereinafter, description is made of matters related to those different points.

The storage unit 220 includes the measurement information storage area 121, the action dictionary information storage area 122, the action information storage area 123, the work dictionary information storage area 124, the work information storage area 125, the environment information storage area 126, and an improvement idea information storage area 227, and is different from the first embodiment in the improvement idea information storage area 227. Therefore, hereinafter, description is made of matters related to the improvement idea information storage area 227.

Information for determining a work as an improvement target and information for determining a work for improving the above-mentioned work are stored in association with each other in the improvement idea information storage area 227.

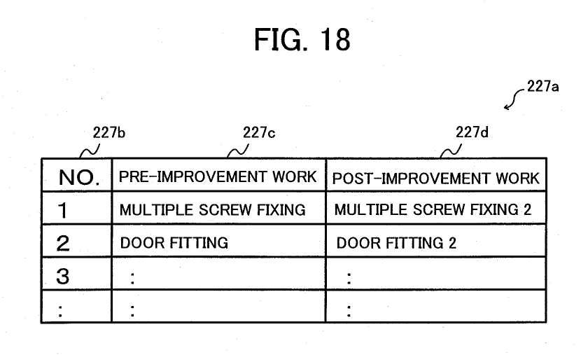

For example, in this embodiment, an improvement idea table 227a as illustrated in FIG. 18 (schematic diagram of the improvement idea table 227a) is stored.

As illustrated in the figure, the improvement idea table 227a includes a No. field 227b, a pre-improvement work field 227c, and a post-improvement work field 227d.

Stored in the No. field 227b is identification information (identification No.) for identifying an improvement idea to be determined in the improvement idea table 227a.

Stored in the pre-improvement work field 227c is information determining a work having an action to be improved. Here, the determination is performed by the same work name as the work name stored in the work field 124b of the work dictionary table 124a.

Stored in the post-improvement work field 227d is information determining a work having an improved action. Here, the determination is performed by the same work name as the work name stored in the work field 124b of the work dictionary table 124a.

Note that in this embodiment, an action column included in the work before the improvement and an action column included in the work after the improvement are previously determined in the work dictionary table 124a.

Referring back to FIG. 17, the control unit 230 includes the measurement information management unit 131, the action analysis unit 132, the work analysis unit 133, and an output information generation unit 234, and is different from the first embodiment in the output information generation unit 234. Therefore, hereinafter, description is made of matters related to the different point.

In the same manner as the first embodiment, the output information generation unit 234 according to this embodiment performs the processing of receiving the input of a search condition, extracting the information corresponding to the input search condition from the work information storage area 125, and outputting the information in the predetermined format, and also outputs information determining the work to be improved.

Specifically, the output information generation unit 234 according to this embodiment receives the input of the search condition, and when extracting the information corresponding to the input search condition from the work table 125a, searches as to whether or not the work name corresponding to the extracted work is stored in the pre-improvement work field 227c of the improvement idea table 227a. If the work name is stored, improvement idea information is generated and output to the output unit 141. The improvement idea information includes the work name of the work before the improvement (work extracted from the work table 125a), the action name of the action included in the work before the improvement (extracted from the work table 125a), the work name of the work after the improvement (extracted from the improvement idea table 227a), and the action name of the action included in the work after the improvement (extracted from the action dictionary table 122a).

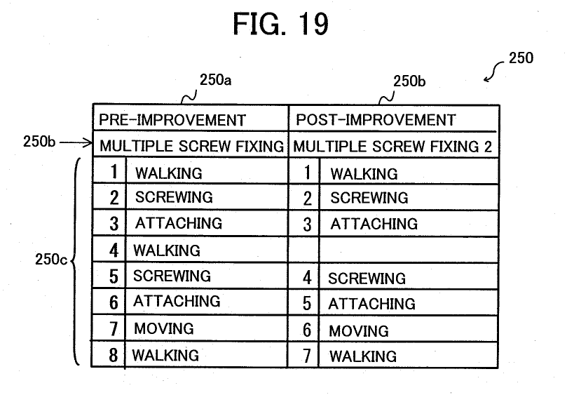

FIG. 19 is a schematic diagram illustrating an example of improvement idea information 250.

The improvement idea information 250 includes a pre-improvement column 250a and a post-improvement column 250b.

In addition, the improvement idea information 250 includes a work name row 250b and an action name row 250c. The work name before the improvement with the actions included in the work before the improvement and the work name after the improvement with the actions included in the work after the improvement are stored in the pre-improvement column 250a and the post-improvement column 250b, respectively.

The work information processing apparatus 210 described above may also be implemented on, for example, the general computer 160 as illustrated in FIG. 13.

For example, the storage unit 220 may be implemented when the CPU 161 uses the memory 162 or the external storage device 163. The control unit 230 may be implemented when a predetermined program stored in the external storage device 163 is loaded into the memory 162 and executed by the CPU 161. The input unit 140 may be implemented when the CPU 161 uses the input device 166. The output unit 141 may be implemented when the CPU 161 uses the output device 167. The communication unit 142 may be implemented when the CPU 161 uses the communication device 168.

The predetermined program may be downloaded onto the external storage device 163 from the storage medium 164 via the reading device 165 or from the network via the communication device 168, then loaded into the memory 162, and executed by the CPU 161. Further, the predetermined program may be loaded directly into the memory 162 from the storage medium 164 via the reading device 165 or from the network via the communication device 168, and executed by the CPU 161.

As described above, in this embodiment, the work that needs to be improved and the actions included in the work, and the work after the improvement and the actions included in the work may be output from the output unit 141 in a list. Therefore, the improvement of the work may be achieved by referencing the above-mentioned improvement idea information 250.

Next, description is made of a third embodiment of the present invention.

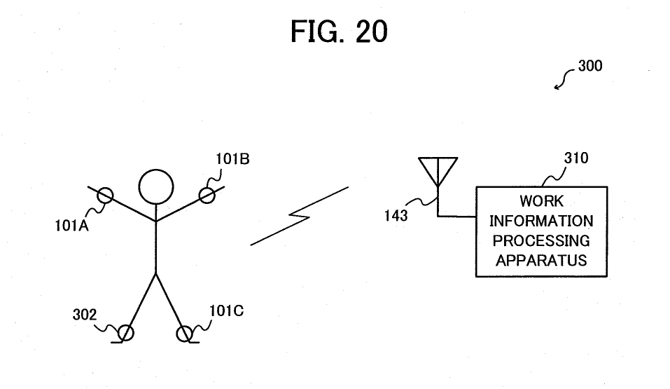

FIG. 20 is a schematic diagram of a work data processing system 300 according to the third embodiment.

The work data processing system 300 according to the present invention includes the sensors 101A, 101B, and 101C (hereinafter, referred to as “sensors 101” unless the individual sensors are particularly distinguished from each other), a position sensor 302, and a work information processing apparatus 310. The sensors 101 are the same as those of the first embodiment, and therefore description thereof is omitted.

The position sensor 302 is a sensor which detects a position of a worker. In this embodiment, a global positioning system (GPS) sensor is used. However, the present invention is not limited to such a mode.

Further, the position sensor 302 transmits detection values that have been detected to the work information processing apparatus 310 via radio.

Note that in FIG. 20, the position sensor 302 is attached to a right foot, but may be attached to an arbitrary position.

The work information processing apparatus 310 receives by the antenna 143 the detection values transmitted from the sensors 101 and the position sensor 302.

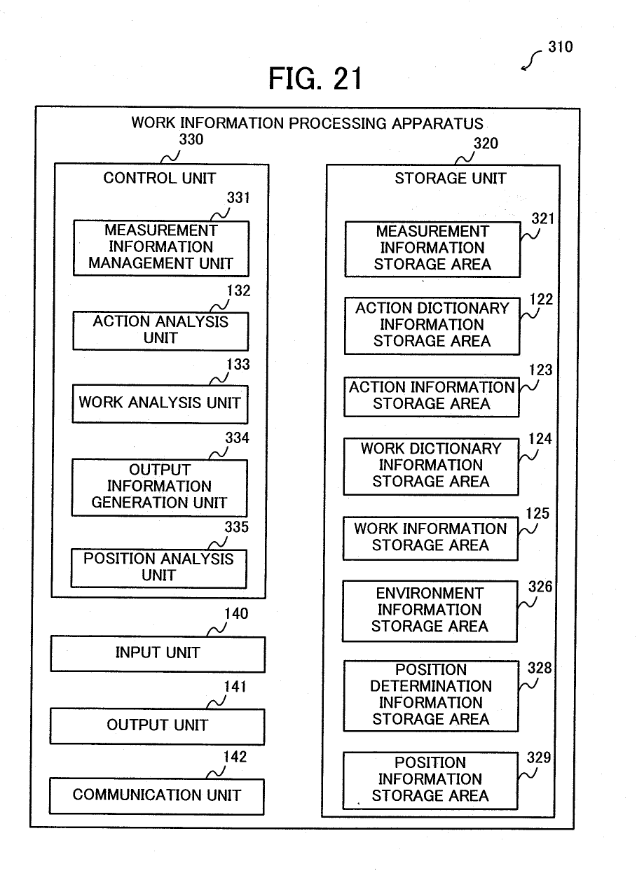

FIG. 21 is a schematic diagram of the work information processing apparatus 310.

As illustrated in the figure, the work information processing apparatus 310 includes a storage unit 320, a control unit 330, the input unit 140, the output unit 141, and the communication unit 142, and is different from the first embodiment in the storage unit 320 and the control unit 330. Therefore, hereinafter, description is made of matters related to those different points.

The storage unit 320 includes a measurement information storage area 321, the action dictionary information storage area 122, the action information storage area 123, the work dictionary information storage area 124, the work information storage area 125, an environment information storage area 326, a position determination information storage area 328, and a position information storage area 329, and is different from the first embodiment in the measurement information storage area 321, the environment information storage area 326, the position determination information storage area 328, and the position information storage area 329. Therefore, hereinafter, description is made of matters related to those different points.

In the measurement information storage area 321, the detection values detected by the position sensor 302 are stored in this embodiment as well as the detection values detected by the sensors 101 are stored in the same manner as the first embodiment.

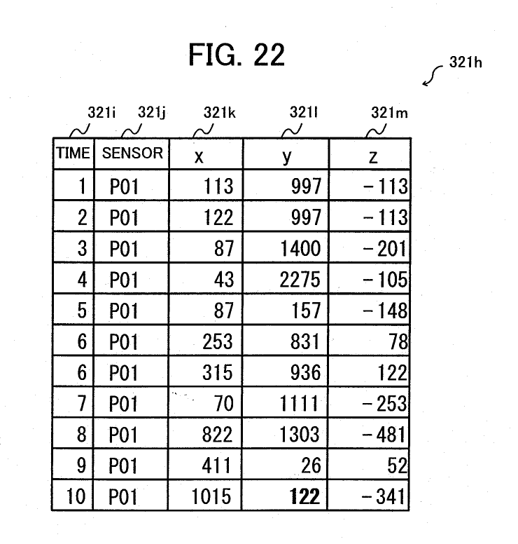

For example, in this embodiment, a position measurement table 321h as illustrated in FIG. 22 (schematic diagram of the position measurement table 321h) is stored in the measurement information storage area 121 in addition to the measurement table 121a as illustrated in FIG. 3.

As illustrated in FIG. 22, the position measurement table 321h includes a time field 321i, a sensor field 321j, an x field 321k, a y field 321l, and a z field 321m.

Stored in the time field 321i is information determining a time at which the detection values detected by the position sensor 302 are received.

Note that times of respective records may be determined by setting the detection values to be periodically transmitted from the position sensor 302 and by setting specific times to be managed by the work information processing apparatus 310 in association with the values stored in the time field 121b.

Stored in the sensor field 321j is information determining an ID which is identification information for identifying the position sensors 302.

Here, in this embodiment, one ID is assigned to each position sensor 302 attached to one worker.

Stored in the x field 321k is information determining a latitude among the detection values detected by the position sensor 302 determined by the sensor field 321j.

Stored in the y field 321l is information determining a longitude among the detection values detected by the position sensor 302 determined by the sensor field 321j.

Stored in the z field 321m is information determining a height among the detection values detected by the position sensor 302 determined by the sensor field 321j.

Note that by attaching an ID which is identification information uniquely assigned to each position sensor 302 to the detection values transmitted from the position sensor 302, it is possible to store the detection values detected by the each position sensor 302 into the corresponding fields 321k, 321l, and 321m.

Referring back to FIG. 21, information for determining an environment of the worker is stored in the environment information storage area 326.

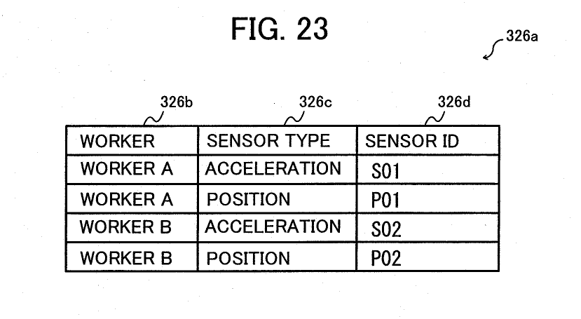

For example, in this embodiment, a correlation table 326a as illustrated in FIG. 23 (schematic diagram of the correlation table 326a) is stored as information for determining a correlation between the worker and the sensors 101 and the position sensor 302, and the grouping table 126f as illustrated in FIG. 9 is stored as information for determining grouping of workers.

As illustrated in FIG. 23, the correlation table 326a includes a worker field 326b, a sensor type field 326c, and a sensor ID field 326d.

Stored in the worker field 326b is identification information (in this embodiment, name of the worker) for identifying the worker.

Stored in the sensor type field 326c is information determining the type of the sensors attached to the worker determined by the worker field 326b. Here, the distinction between the acceleration sensor and the position sensor is stored in this embodiment.

Stored in the sensor ID field 326d is information determining the set of the sensors 101 or the position sensor 302 attached to the worker determined by the worker field 326b.

Referring back to FIG. 21, information for determining a space (place) corresponding to the detection values detected by the position sensor 302 is stored in the position determination information storage area 328.

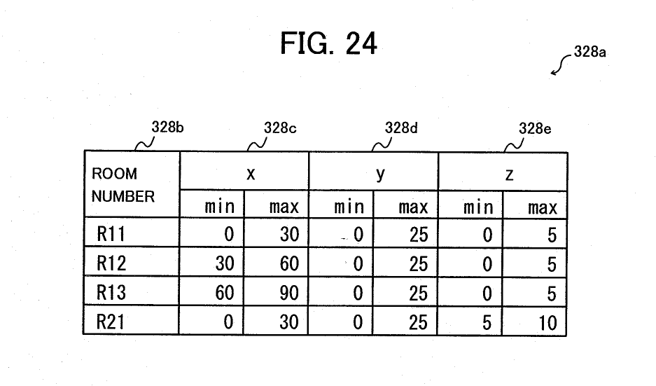

For example, in this embodiment, a position determination table 328a as illustrated in FIG. 24 (schematic diagram of the position determination table 328a) is stored in the position determination information storage area 328.

As illustrated in the figure, the position determination table 328a includes a room number field 328b, an x range field 328c, a y range field 328d, a z range field 328e.

Stored in the room number field 328b is information determining a room in which the work is performed. Here, in this embodiment, a room number assigned to each room is stored as the information determining the room in which the work is performed, but the present invention is not limited to such a mode.

Store in the x range field 328c is information determining a range of the latitude of the room determined by the room number field 328b. Here, in this embodiment, a minimum value (min) and a maximum value (max) of the latitude of the room determined by the room number field 328b are stored.

Store in the y range field 328d is information determining a range of the longitude of the room determined by the room number field 328b. Here, in this embodiment, a minimum value (min) and a maximum value (max) of the longitude of the room determined by the room number field 328b are stored.

Store in the z range field 328e is information determining a range of the height of the room determined by the room number field 328b. Here, in this embodiment, a minimum value (min) and a maximum value (max) of the height of the room determined by the room number field 328b are stored.

Referring back to FIG. 21, information for determining a space (place) in which the worker has been present based on the detection values detected by the position sensor 302 is stored in the position information storage area 329.

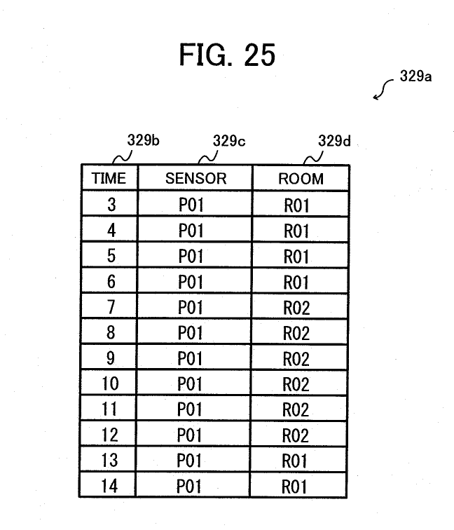

For example, in this embodiment, a position table 329a as illustrated in FIG. 25 (schematic diagram of the position table 329a) is stored in the position information storage area 329.

As illustrated in the figure, the position table 329a includes a time field 329b, a sensor field 329c, and a room field 329d.

Stored in the time field 329b is information determining a time at which the detection values transmitted from the position sensor 302 are received.

Store in the sensor field 329c is information determining the position sensor 302 (here, ID of the position sensor 302).

Store in the room field 329d is information determining the space (place) indicated by the detection values detected by the position sensor 302 determined by the sensor field 329c at the time determined by the time field 329b. Note that, stored in this field is the room number stored in the room number field 328b corresponding to the record in which the detection values detected by the position sensor 302 are included in the x range field 328c, the y range field 328d, and the z range field 328e of the position determination table 328a.

Referring back to FIG. 21, the control unit 330 includes a measurement information management unit 331, the action analysis unit 132, the work analysis unit 133, an output information generation unit 334, and a position analysis unit 335.

The measurement information management unit 331 performs a processing of storing the measurement values received from the respective sensors 101 and the position sensor 302 via the communication unit 142 described later into the measurement table 121a and the position measurement table 321h.

The position analysis unit 335 performs a processing of determining the space (place) in which the worker has been present from the detection values detected by the position sensor 302.

Specifically, the position analysis unit 335 extracts information determining the longitude, the latitude, and the height stored in the x field 321k, the y field 321l, and the z field 321m of the position measurement table 321h on a time basis, determines the record in which the extracted information determining the longitude, the latitude, and the height is included in the longitude range, the latitude range, and the height range that are determined by the x range field 328c, the y range field 328d, and the z range field 328e, respectively, of the position determination table 328a and extracts the room number stored in the room number field 328b of the record.

Then, by storing the extracted room number, the ID of the position sensor 302, and the information determining the time at which the detection is performed by the position sensor 302 into the time field 329b, the sensor field 329c, and the room field 329d, the position analysis unit 335 generates the position table 329a, and stores the position table 329a into the position information storage area 329.

The output information generation unit 334 performs a processing of receiving the input of a search condition via the input unit 140, extracting the information corresponding to the input search condition from the work information storage area 125 and the position information storage area 329, and outputting the information in a predetermined format.

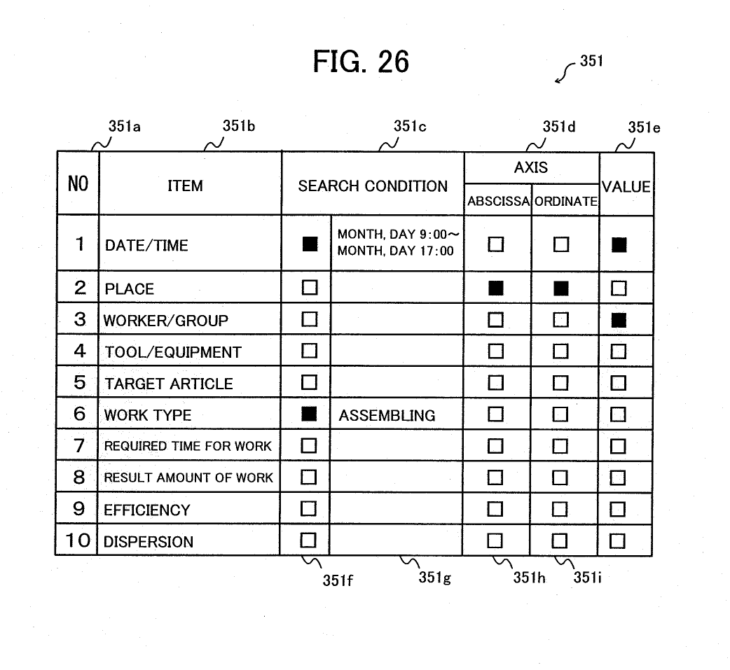

Specifically, the output information generation unit 334, for example, controls the output unit 141 to display a search condition input screen 351 as illustrated in FIG. 26 (schematic diagram of the search condition input screen 351), receives inputs of a necessary search condition and an output mode via the input unit 140, performs a search with the input search condition, and then performs an output in the input output mode.

As illustrated in the figure, the search condition input screen 351 includes a NO. field 351a, an item field 351b, a search condition field 351c, an axis field 351d, and a value field 351e.

Stored in the NO. field 351a is an identification number for identifying each item.

Stored in the item field 351b is information determining an item for which a selection is performed in the search condition field 351c, the axis field 351d, or the value field 351e.

The search condition field 351c receives the input of the condition for performing a search from the work information storage area 125 and the position information storage area 329.

Here, the search condition field 351c includes a selection field 351f and an input field 351g. In addition, when an instruction for selection is input to the selection field 351f (the selection field 351f is checked) via the input unit 140 and when a search target is input to the input field 351g, the output information generation unit 334 extracts the information corresponding to the input search condition from the work information storage area 125 and the position information storage area 329.

Note that if the item field 351b is “date/time”, the start date/time and the end date/time when the search is performed are input to the input field 351g.

If the item field 351b is “place”, the work place (room number) is input to the input field 351g as the search target.

If the item field 351b is “worker/group”, the worker name or the group name is input to the input field 351g as the search target.

If the item field 351b is “tool/equipment”, the tool name or the equipment name is input to the input field 351g as the search target.

For example, in a case where an electric screwdriver is found to be used when the screwing action or the work of screw fixing is performed, or other similar cases where a specific tool is used in an action determined by the action dictionary table 122a or a work determined by the work dictionary table 124a, the work or the action is found out based on the corresponding tool, and may be output. Further, in a case where a specific equipment is used, a place in which such an equipment is located may be determined.

Therefore, for example, by storing a table in which a tool is associated with an action or a work into the storage unit 320 in advance, it is possible to determine the action or the work from the tool determined by the input field 351g to search the work table 125a.

In addition, by storing a table in which an equipment is associated with a room number into the storage unit 320 in advance, it is possible to search the position table 329a.

In addition, by including data representing the tool or the equipment in work instruction data for instructing the worker's work in advance, and by inputting such data via the input unit 140 and storing the data into the storage unit 320 in advance, the output information generation unit 334 may search for the worker's work, the working time, or the like from the tool or the equipment.

If the item field 351b is “target article”, the name of an article (such as finished article or article in transit) as the target of the work is input to the input field 351g as the search target.

For example, in a case where the target article is found to be a screw when the screwing action or the work of screw fixing is performed, or other similar cases where a specific article is targeted in an action determined by the action dictionary table 122a or a work determined by the work dictionary table 124a, the work or the action may be determined based on the input target article. Further, in a case where a plurality of articles are produced, a production place (room number) for each of the articles is often a specific place, and hence the place (room) may be determined by the input target article.

Therefore, for example, by storing a table in which a target article is associated with an action or a work into the storage unit 320 in advance, it is possible to determine the action or the work from the target article determined by the input field 351g to search the work table 125a.

In addition, by storing a table in which a target article is associated with a room number into the storage unit 320 in advance, it is possible to search the position table 329a.

If the item field 351b is “work type”, the work name is input to the input field 351g as the search target.

If the item field 351b is “required time for work”, a character string indicating that the required time for the work is “short”, “normal”, or “short” is input to the input field 351g as the search target.

Here, the required time for the work represents a time taken from the start time of a specific work until the completion time thereof. In the work table 125a, data determining the time is associated with the action and the work, and hence the required time for the work may be obtained as a difference between the completion time and the start time. Further, if it is judged from the work table 125a that a plurality of works are performed successively, the required time for the work may be obtained as a difference between the start time of a target work and the start time of the subsequent work.

Then, the required time for the work is classified into “short”, “normal”, or “short” according to a predefined threshold value, thereby allowing the work classified into each thereof to be determined.

If the item field 351b is “result amount of work”, a character string indicating that the result amount of the work is “small”, “regular”, or “large” is input to the input field 351g as the search target.

Here, the result amount of the work represents the amount of the work that has been performed during the input time, and is expressed as such a numerical value as to indicate how many articles have been assembled in an assembling work, or how many articles have been conveyed in a conveyance work. This may be calculated by prestoring the number of articles output in the actual work per working time in the storage unit 320 on a work basis.

As described above, by storing the number of articles output in the actual work, the result amount of the work is classified into “small”, “regular”, or “large” according to a predefined threshold value, thereby allowing the work classified into each thereof to be determined.

If the item field 351b is “efficiency”, a character string indicating that the efficiency of the work is “low”, “normal”, or “high” is input to the input field 351g as the search target.

The efficiency represents the result amount of the work converted into an amount per given number of persons or per given time. In a normal case, a numerical value per person, per hour, or per day is often used. In the embodiment of the present invention, the efficiency is obtained by dividing the result amount of the work by the number of engaged workers and the required time for the work. Sometimes used is the reciprocal of the obtained value corresponding to a time required for one work.

Alternatively, in a case where one worker performs a plurality of works, the efficiency of the work may be expressed by combining a plurality of indices such as the number of times of Work A and the number of times of Work B during the input time. Further, by weighting the respective works in advance, a comprehensive index calculated by adding the weights thereof multiplied by the numbers of times of the respective works may be used. The numbers of times the respective works are carried out, which are used for calculating those indices, may be obtained as the numbers of times of the works extracted by analyzing the measurement data.

The efficiency thus calculated is classified into “low”, “normal”, or “high” according to a predefined threshold value, thereby allowing the work classified into each thereof to be determined.

If the item field 351b is “dispersion”, a character string indicating that the dispersion in the work is “low”, “normal”, or “high” is input to the input field 351g as the search target.

The dispersion represents a person-basis difference, a time-basis difference, or the like in the efficiency of the workers belonging to a group, and is expressed by a set of numerical values, a standard deviation, or the like.

The dispersion thus calculated is classified into “low”, “normal”, or “high” according to a predefined threshold value, thereby allowing the group (worker) classified into each thereof to be determined.

Received in the axis field 351d is a selection of axes used in a case where a value selected by the value field 351e described later is displayed in coordinates. In other words, an instruction for the selection is input (checked) via the input unit 140 to the axis field 351d corresponding to the item determined by the item field 351b, thereby setting the selected item as the axis.

Here, the axis field 351d includes an abscissa axis field 351h and an ordinate axis field 351i, and allows items to be selected separately in the respective fields.

Specifically, if the item determined by the axis field 351d is “date/time”, values of the axis are defined at predetermined time intervals spaced apart from an origin position predefined in the coordinates.

If the item determined by the axis field 351d is “place”, predefined work places (room numbers) are located in predefined positions spaced apart from the origin position predefined in the coordinates.

If the item determined by the axis field 351d is “worker/group”, the worker names or the group names are located in predefined positions spaced apart from the origin position predefined in the coordinates.

If the item determined by the axis field 351d is “tool/equipment”, the tool names or the equipment names are located in predefined positions spaced apart from the origin position predefined in the coordinates.

If the item determined by the axis f field 351d is “target article”, the names of an article (such as finished article or article in transit) as the target of the work are located in predefined positions spaced apart from the origin position predefined in the coordinates.

If the item determined by the axis field 351d is “work type”, predefined work names are input in predefined positions spaced apart from the origin position predefined in the coordinates.

If the item determined by the axis field 351d is “required time for work”, “result amount of work”, “efficiency”, or “dispersion”, predefined classes are located in predefined positions spaced apart from the origin position predefined in the coordinates.

Received in the value field 351e is a selection of the value to be displayed in the coordinates determined by the axis field 351d. In other words, the instruction for the selection is input (checked) via the input unit 140 to the value field 351e corresponding to the item determined by the item field 351b, thereby displaying the value corresponding to the selected item in the coordinates determined by the axis field 351d.

Referring back to FIG. 21, the output information generation unit 334 performs a processing of searching the work table 125a and the position table 329a according to the search condition input to the search condition field 351c of the search condition input screen 351, extracting the value determined by the value field 351e from the information matching the search condition, generating an output screen for displaying the extracted value in the coordinates determined by the axis field 351d, and outputting the output screen to the output unit 141.

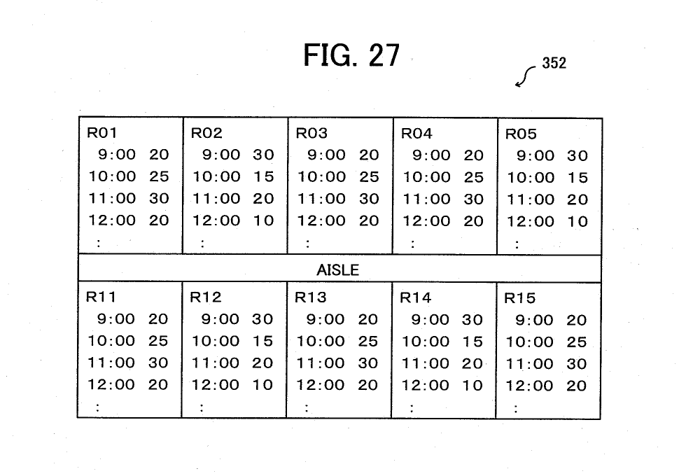

For example, FIG. 27 is a schematic diagram of an output screen 352.

The output screen 352 indicates a case where: “date/time” and “work type” are selected in the search condition field 351c while “9:00 to 17:00” and “assembling” are input to the input field 351g; “place” is selected in the abscissa axis field 351h and the ordinate axis field 351i of the axis field 351d; and “date/time” and “worker/group” are selected in the value field 351e.

For example, data involved in the work of the assembly performed during 9:00-17:00 specified as the search condition is extracted from the work information storage area 125 and the position information storage area 329, and the date/time and the value of the worker/group (here, number of persons) that are specified in the value field are displayed in the form of a two-dimensional map based on the place specified in the abscissa axis field 351h and the ordinate axis field 351i. FIG. 27 illustrates a two-dimensional map in which ten rooms in total are arranged with five rooms spaced apart from the other five rooms by an aisle, on which the numbers of persons engaged in the assembling work on the time basis during 9:00-17:00 are displayed in each room.

As described above, if “place” is selected in the abscissa axis field 351h and the ordinate axis field 351i of the axis field 351d, the value is displayed on the two-dimensional map.

The work information processing apparatus 310 described above may also be implemented on, for example, the general computer 160 as illustrated in FIG. 13.

For example, the storage unit 320 may be implemented when the CPU 161 uses the memory 162 or the external storage device 163. The control unit 330 may be implemented when a predetermined program stored in the external storage device 163 is loaded into the memory 162 and executed by the CPU 161. The input unit 140 may be implemented when the CPU 161 uses the input device 166. The output unit 141 may be implemented when the CPU 161 uses the output device 167. The communication unit 142 may be implemented when the CPU 161 uses the communication device 168.

The predetermined program may be downloaded onto the external storage device 163 from the storage medium 164 via the reading device 165 or from the network via the communication device 168, then loaded into the memory 162, and executed by the CPU 161. Further, the predetermined program may be loaded directly into the memory 162 from the storage medium 164 via the reading device 165 or from the network via the communication device 168, and executed by the CPU 161.

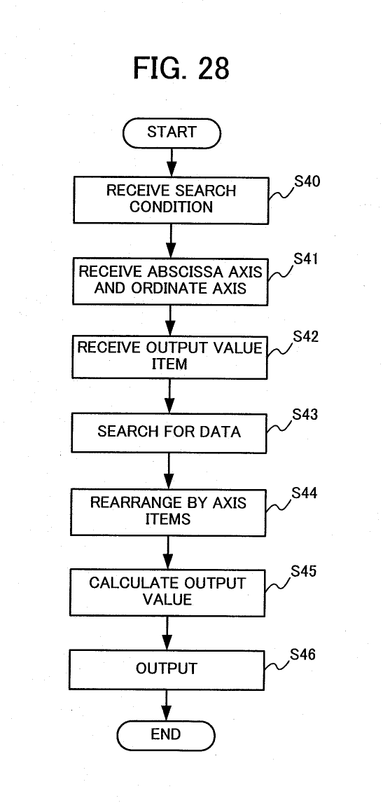

FIG. 28 is a flowchart illustrating a processing of generating an output screen performed by the output information generation unit 334.

First, the output information generation unit 334 outputs the search condition input screen 351 as illustrated in FIG. 26 to the output unit 141, and receives the input of a search condition in the search condition field 351c via the input unit 140 (S40).

Subsequently, the output information generation unit 334 receives the selection of items as those of the abscissa axis and the ordinate axis in the axis field 351d of the search condition input screen 351 (S41).

Subsequently, the output information generation unit 334 receives the selection of items as output values in the value field 351e of the search condition input screen 351 (S42).

Subsequently, the output information generation unit 334 searches the work table 125a and the position table 329a for necessary data based on the search condition input in Step S40 (S43).

Subsequently, the output information generation unit 334 rearranges the data items retrieved in Step S43 according to the items corresponding to the abscissa axis and the ordinate axis input in Step S41 (S44).

Subsequently, the output information generation unit 334 calculates a value to be output based on the received output value item input in Step S42 (S45).

Then, the output information generation unit 334 generates an output screen by placing the value calculated in Step S45 in the coordinates obtained by the rearrangement in Step S44, and outputs the output screen to the output unit 141 (S46).

The generation of the output screen is performed by the output information generation unit 334 in such a procedure as described above, and hence the items of the search condition, the axes, and the value that are specified in the search condition input screen 351 are independent of one another, allowing various combinations to be received.

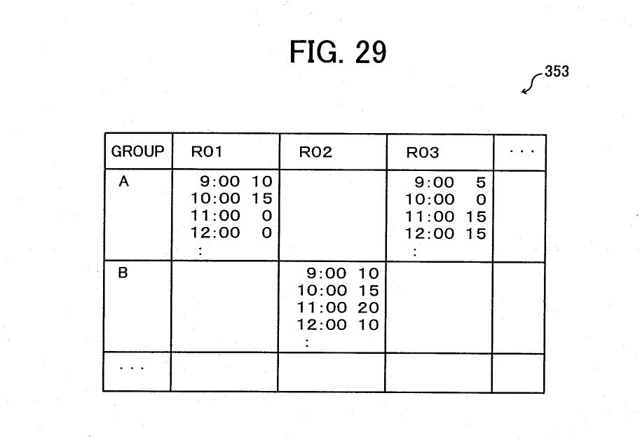

For example, FIG. 29 is a schematic diagram of a display screen 353 obtained by setting the ordinate axis as the group name, the abscissa axis as the room number, and the value as the date/time and the worker.

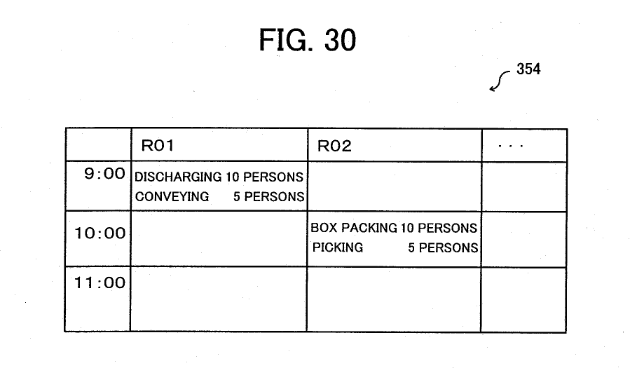

Alternatively, FIG. 30 is a schematic diagram of a display screen 354 obtained by setting the ordinate axis as the time, the abscissa axis as the room number, and the value as the work type and the worker.

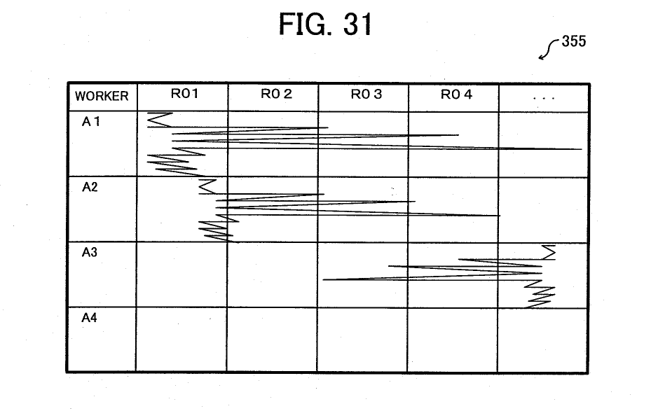

Alternatively, FIG. 31 is a schematic diagram of a display screen 355 obtained by setting the ordinate axis as the worker, the abscissa axis as the place, and the value as the efficiency. Here, in FIG. 31, the values of the efficiency are plotted, and the plotted values are connected to each other with a straight line, thereby being presented in the form of a graph.

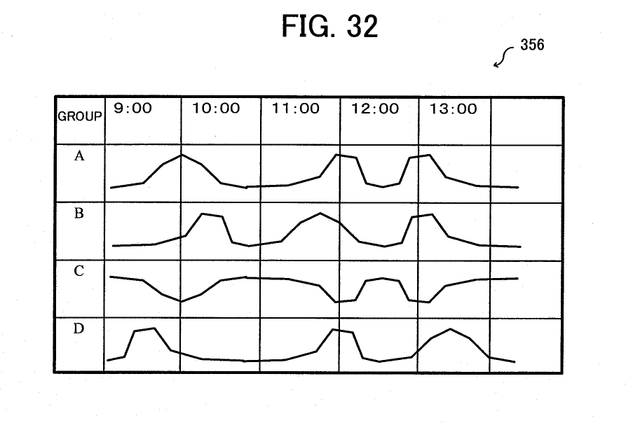

Alternatively, FIG. 32 is a schematic diagram of a display screen 356 obtained by setting the ordinate axis as the group name, the abscissa axis as the date/time, and the value as the result amount of the work.

Note that in the third embodiment, the display screen as described above is output to the output unit 141, but the present invention is not limited to such a mode. For example, as in the first embodiment, the output information generation unit 334 may receive the input of the name of the worker or the group name via the input unit 140, and output, to the output unit 141, the information determining the action of the worker included in the group determined by the name of the worker or the group name, the information determining the work, the information determining the time at which the action and the work have been performed, and the information determining the place (room) in which the work has been performed.

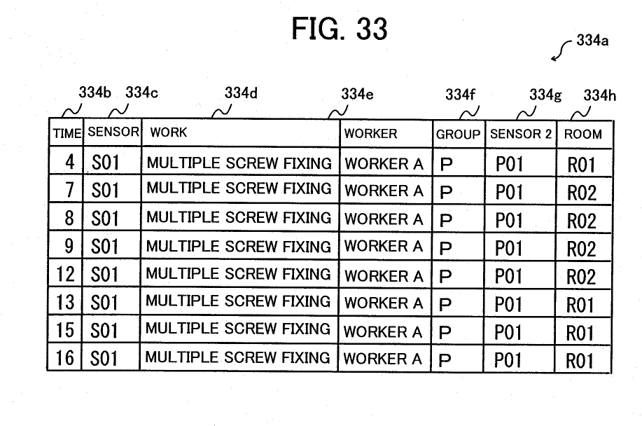

FIG. 33 is a schematic diagram of output information 334a obtained in such a case.

As illustrated in the figure, the output information 334a includes a time field 334b, a sensor field 334c, a work field 334d, a worker field 334e, a group field 334f, a second sensor field 334g, and a room field 334h, in each of which information extracted by the output information generation unit 334 and its related information are stored.

The embodiments described above illustrate the example of using the work data processing system when manufacturing an article, but the present invention is not limited to such a mode. For example, such a system may be applied to operations at a restaurant.

For example, when a chef, a waiter, a waitress, or the like who is engaged in the operations at the restaurant performs the operations as usual while wearing the acceleration sensor, the position sensor, and the like, the measurement values corresponding to his/her actions are collected, and information may be output by analyzing those measurement values.

Prestored in the action dictionary table are not only the general actions such as moving but also action information that is unique to the respective operations and is related to lifting a pan, stirring food during cooking while moving a wok, setting the table, clearing away the dishes, and the like.

Further prestored in the work dictionary table is work information related to cooking, clearance, table setting, ushering, order taking, and the like, each of which includes a plurality of actions.

By using those action dictionary table and work dictionary table, order data collected separately, and the like, it is possible to analyze and estimate contents of the work of the respective workers, the work place, and the like from the measurement values before outputting thereof.

When the output data is used, it is possible to know a worker-basis difference, a time-basis difference, or the like in the efficiency of the work, a candidate item to be improved, and the like. Accordingly, the above-mentioned system may be used for improving the operations.

Alternatively, the system described above may be applied to operations at a distributor.

When a salesclerk, a person in charge of storage and retrieval, or the like who is engaged in the operations at the distributor performs the operations as usual while wearing the acceleration sensor, the position sensor, and the like, the measurement values corresponding to his/her actions are collected, and may be output by the analysis thereof.

Prestored in the action dictionary table are not only the general actions such as moving but also action information that is unique to the respective operations and is related to ushering, giving an explanation to a customer, moving merchandise in a warehouse, placing goods in a sales area, and the like.

Further prestored in the work dictionary table is work information related to sales, inventory management, storage and retrieval, and the like, each of which includes a plurality of actions.

By using those action dictionary table and work dictionary table, order data collected separately, and the like, it is possible to analyze and estimate the contents of the work of the respective workers, the work place, and the like from the measurement values before outputting thereof.

When the output data is used, it is possible to know the worker-basis difference, the time-basis difference, or the like in the efficiency of the work, the candidate item to be improved, and the like. Accordingly, the above-mentioned system may be used for improving the operations.

1-19. (canceled)

20. A work information processing apparatus, comprising:
a storage unit which stores:
action dictionary information for determining detection information determining a detection value obtained by a sensor which senses an action, and the action corresponding to the detection information; and
work dictionary information for determining combination information determining a combination of actions in time sequence, and a work corresponding to the combination information;
a control unit;
an input unit; and
an output unit, wherein:
the storage unit further stores grouping information for determining a worker and a group to which the worker belongs; and
the control unit performs:
a processing of determining actions corresponding to detection values obtained by the sensor owned by the worker from the action dictionary information;
a processing of determining a combination of the determined actions in time sequence, and determining a work corresponding to the determined combination from the work dictionary information;
a processing of generating work information for determining actions and works in time sequence for each of the workers; and
a processing of receiving information determining the group as search information via the input unit, determining the worker belonging to the determined group from the grouping information, and outputting at least one of the action and the work of the determined worker, in a specific format via the output unit.

21. A work information processing apparatus, comprising:
a storage unit which stores:
action dictionary information for determining detection information determining a detection value obtained by a sensor which senses an action, and the action corresponding to the detection information; and
work dictionary information for determining combination information determining a combination of actions in time sequence, and a work corresponding to the combination information;
a control unit;
an input unit; and
an output unit, wherein:
the storage unit further stores:
tool/equipment information for determining a tool, an equipment, and a work place in which the tool and the equipment are used; and
target article information for determining a target article and a work in which the target article is targeted; and
the control unit performs:
a processing of determining actions corresponding to detection values obtained by the sensor owned by a worker from the action dictionary information;
a processing of determining a combination of the determined actions in time sequence, and determining a work corresponding to the determined combination from the work dictionary information;
a processing of receiving an input via the input unit by setting, as a search target, at least one of a date/time, a place, the worker, the tool or the equipment, the target article, a work type, and a required time for the work;
a processing of receiving the input via the input unit by setting, as coordinate axes, at least two of the date/time, the place, the worker, the tool or the equipment, the target article, the work type, and the required time for the work;
a processing of receiving the input via the input unit by setting, as a display target, at least one of values of the date/time, the place, the worker, the tool or the equipment, the target article, the work type, and the required time for the work;
a processing of determining a work corresponding to the search target;
a processing of extracting the values of the date/time, the place, the worker, the tool or the equipment, the target article, the work type, and the required time for the work that are input as the display target with regard to the determined work; and
a processing of generating a display screen in which the extracted values are arranged in positions corresponding to a combination of the date/time, the place, the worker, the tool or the equipment, the target article, the work type, and the required time for the work that are input as the coordinate axes.

22. A program controlling a computer to function as:
storage means which stores:
action dictionary information for determining detection information determining a detection value obtained by a sensor which senses sensing an action, and the action corresponding to the detection information; and
work dictionary information for determining combination information determining a combination of actions in time sequence, and a work corresponding to the combination information; and
control means,
the storage unit further storing grouping information for determining a worker and a group to which the worker belongs,
the program further controlling the control means to perform:
a processing of determining actions corresponding to detection values obtained by the sensor owned by the worker from the action dictionary information;
a processing of determining a combination of the determined actions in time sequence, and determining a work corresponding to the determined combination from the work dictionary information;
a processing of generating work information for determining actions and works in time sequence for each of the workers; and
a processing of receiving information determining the group as search information via input means, determining the worker belonging to the determined group from the grouping information, and outputting at least one of the action and the work of the determined worker, in a specific format via output means.

23. A program controlling a computer to function as:
storage means which stores:
action dictionary information for determining detection information determining a detection value obtained by a sensor which senses sensing an action, and the action corresponding to the detection information; and
work dictionary information for determining combination information determining a combination of actions in time sequence, and a work corresponding to the combination information; and
control means,
the storage means further storing:
tool/equipment information for determining a tool, an equipment, and a work place in which the tool and the equipment are used; and
target article information for determining a target article and a work in which the target article is targeted; and
the program further controlling the control means to perform:
a processing of determining actions corresponding to detection values obtained by the sensor owned by a worker from the action dictionary information;
a processing of determining a combination of the determined actions in time sequence, and determining a work corresponding to the determined combination from the work dictionary information;
a processing of receiving an input via input means by setting, as a search target, at least one of a date/time, a place, the worker, the tool or the equipment, the target article, a work type, and a required time for the work;
a processing of receiving the input via the input means by setting, as coordinate axes, at least two of the date/time, the place, the worker, the tool or the equipment, the target article, the work type, and the required time for the work;
a processing of receiving the input via the input means by setting, as a display target, at least one of values of the date/time, the place, the worker, the tool or the equipment, the target article, the work type, and the required time for the work;
a processing of determining a work corresponding to the search target;
a processing of extracting the values of the date/time, the place, the worker, the tool or the equipment, the target article, the work type, and the required time for the work that are input as the display target with regard to the determined work; and
a processing of generating a display screen in which the extracted values are arranged in positions corresponding to a combination of the date/time, the place, the worker, the tool or the equipment, the target article, the work type, and the required time for the work that are input as the coordinate axes.
